(19) United States
(12) Patent Application Publication
(10) Pub. No.: US 2006/0061987 A1
(43) Pub. Date: Mar. 23, 2006

(54) Decoration with three dimensional structure

(76) Inventor: Thomas Yeh, Taipei (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/944,743

(22) Filed: Sep. 21, 2004

(51) Int. Cl. F21S 6/00

(52) U.S. Cl. 362/123; 362/124; 362/191

(57) ABSTRACT

A decoration with three dimensional structure includes a sheet main body having a pressed area to show a specific figure. The specific figure has an outer configuration corresponding to an inner configuration of the pressed area, and is connected to and maintained at a desired position relative to the main body via at least one connecting section extended between the main body and the specific figure. At least one light-emitting module is attached to a rear side of the main body to emit light that is projected toward the pressed area and visible from a front side of the main body. The main body may alternatively includes a sideward extension, which also includes a pressed area to show a specific figure matching that formed on the main body to create an integral decoration.

### FIELD OF THE INVENTION

The present invention relates to a decoration, and more particularly to a decoration with three dimensional structure.

### BACKGROUND OF THE INVENTION

Various kinds of decorations are often positioned or hung in houses or offices to beautify people's living or working environment. The most frequently used decorations include, for example, artificial flower, works of art, paintings, lamps, etc. Each type of these decorations creates a different ornamental and visual esthetics. The currently commercially available decorations are either pure works of art or machine-made products. Generally speaking, decorations in the nature of work of art are usually wholly or partially hand-made and therefore require increased labor and time costs. It is uneasy for the hand-made decorations, even produced in the same batch, to have a uniform quality. On the other hand, while the machine-made decorations have a uniform quality, they inevitably look to be monotonous and commonplace.

It is therefore desirable to provide consumers with an alternative decoration that is visually esthetical and combines modern arts and crafts.

### SUMMARY OF THE INVENTION

A primary object of the present invention is to provide a decoration with three dimensional structure, in which a sheet material is pressed to form a decoration that combines advantages of modern arts and crafts, and creates visual esthetics.

Another object of the present invention is to provide a decoration with three dimensional structure that creates a special, stereo visual beauty on a sheet material.

A further object of the present invention is to provide a decoration with three dimensional structure that includes a sheet main body having a pressed area to show a specific figure and a sideward extension having a pressed area to show another specific figure matching that on the sheet main body while creating a shadow effect.

A still further object of the present invention is to provide a decoration with three dimensional structure that can be mass-produced to have a uniform quality.

A still further object of the present invention is to provide a decoration with three dimensional structure that includes means to emit a light source. The light emitting means may include at least one light-emitting module attached to a rear side of a sheet main body having a pressed area. Light emitted from the light-emitting module is projected toward the pressed area and visible from a front side of the decoration to create a special visual effect. When more than one light-emitting module is located at different positions behind the main body, changeful lighting and visual effects can be created.

To achieve the above objects, in accordance with the present invention, there is provided decoration with three dimensional structure which includes a sheet main body having a pressed area to show a specific figure. The specific figure has an outer configuration corresponding to an inner configuration of the pressed area, and is connected to and maintained at a desired position relative to the main body via at least one connecting section extended between the main body and the specific figure. At least one light-emitting module is attached to a rear side of the main body to emit light that is projected toward the pressed area and visible from a front side of the main body. The main body may alternatively includes a sideward extension, which also includes a pressed area to show a specific figure matching that formed on the main body to create an integral decoration.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein:

FIG. 1 is a front perspective view of a decoration with three dimensional structure according to a first embodiment of the present invention;

FIG. 2 is a sectional view taken along line 2-2 of FIG. 1;

FIG. 3 is a rear perspective view of the decoration of FIG. 1;

FIG. 4 is similar to FIG. 3 with light-emitting modules separated from a rear side of the decoration;

FIG. 5 is an exploded rear perspective view of a light-emitting module used in the decoration of the present invention;

FIG. 6 is a front perspective view of a decoration with three dimensional structure according to a second embodiment of the present invention;

FIG. 7 is a front perspective view of a decoration with three dimensional structure according to a third embodiment of the present invention;

FIG. 8 is a front perspective view of a decoration with three dimensional structure according to a fourth embodiment of the present invention;

FIG. 9 is a front perspective view of a decoration with three dimensional structure according to a fifth embodiment of the present invention; and

FIG. 10 is a front perspective view of a decoration with three dimensional structure according to a sixth embodiment of the present invention.

### DETAILED DESCRIPTION OF THE PREFERRED EMBODIMENTS

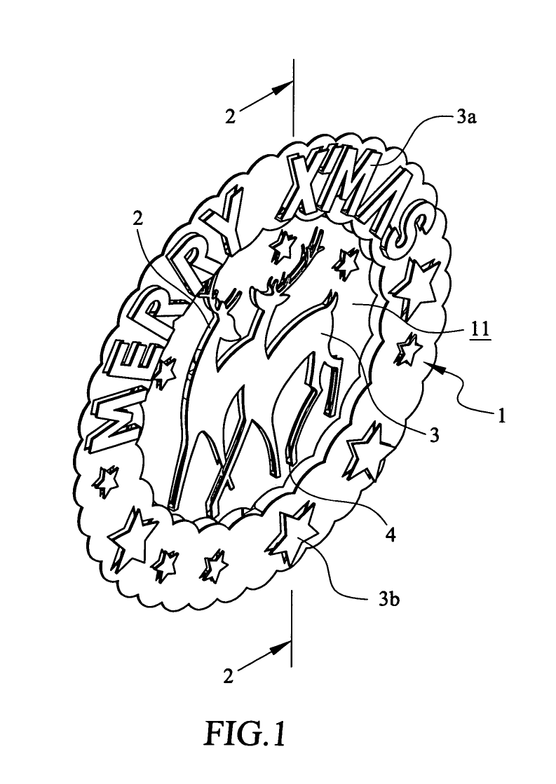

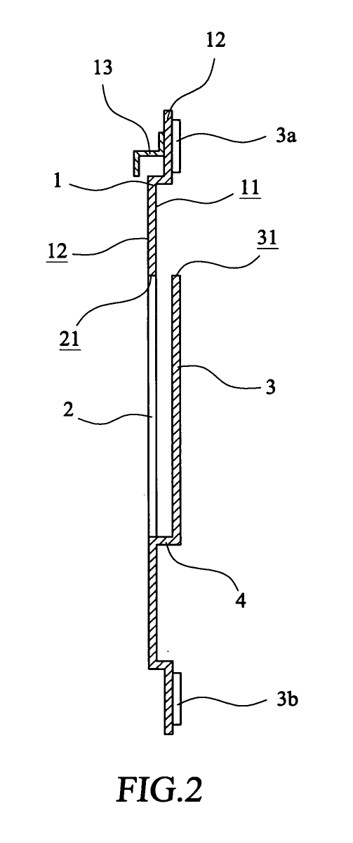

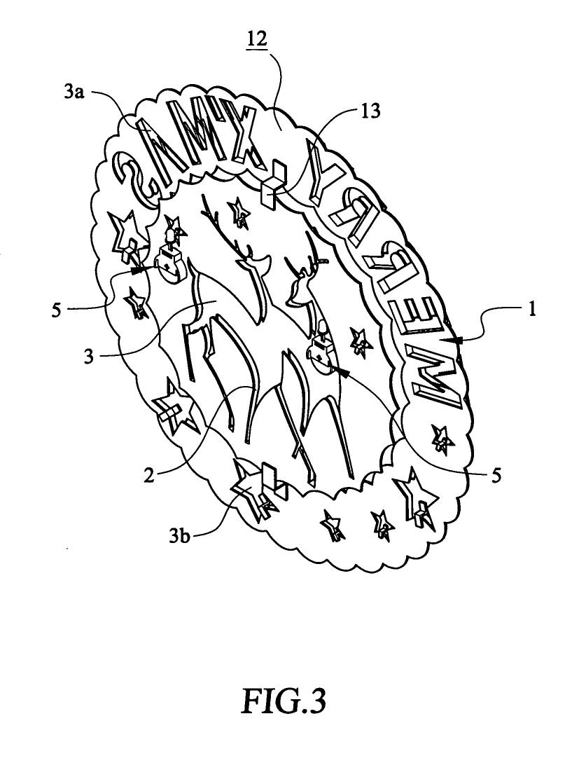

Please refer to FIG. 1 that is a front perspective view of a decoration with three dimensional structure according to a first embodiment of the present invention, FIG. 2 that is a sectional view taken along line 2-2 of FIG. 1, and FIG. 3 that is a rear view of FIG. 1. As shown, the decoration with three dimensional structure of FIG. 1 includes a sheet main body 1 having a first or front surface 11 and a second or rear surface 12. A selected area of the sheet main body 1 is pressed from the second surface 12 toward the first surface 11 by a predetermined distance to form a pressed area 2 showing a specific FIG. 3. That is, the FIG. 3 formed by pressing the sheet main body 1 has an outer configuration 31 corresponding to an inner configuration 21 of the pressed area 2.

In addition to the FIG. 3, other characters 3a and/or patterns 3b may also be formed at other areas on the sheet main body 1 in the same pressing manner to provide a decoration showing excellent visual esthetics. A hanger 13 may be provided at a suitable position on the second surface 12 of the sheet main body 1 for hanging the decoration on a wall or some other suitable place.

At least a connecting section 4 is left between the inner configuration 21 of the pressed area 2 and the outer configuration 31 of the FIG. 3 to keep the FIG. 3 at a desired position relative to the sheet main body 1 and the pressed area 2. For example, the FIG. 3 may be kept in parallel with, perpendicular to, or tilted at an angle from the sheet main body 1.

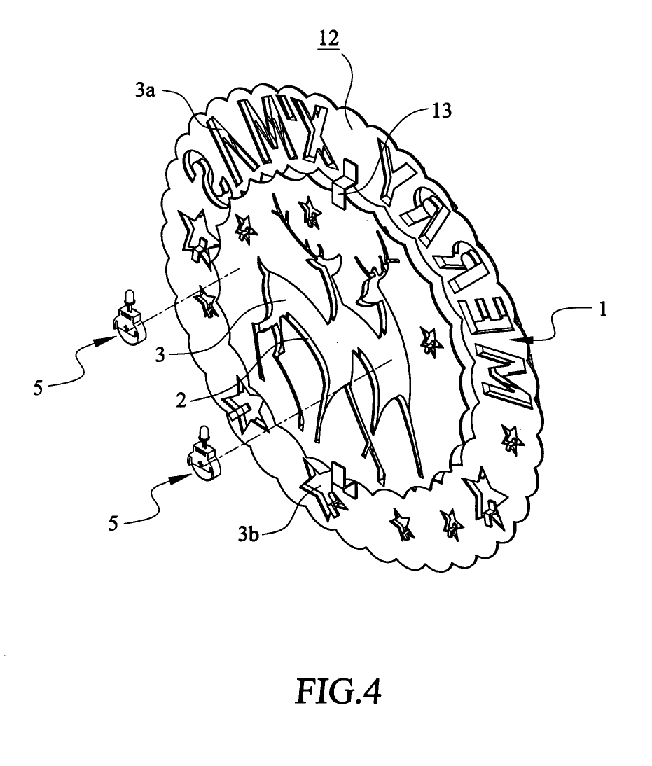

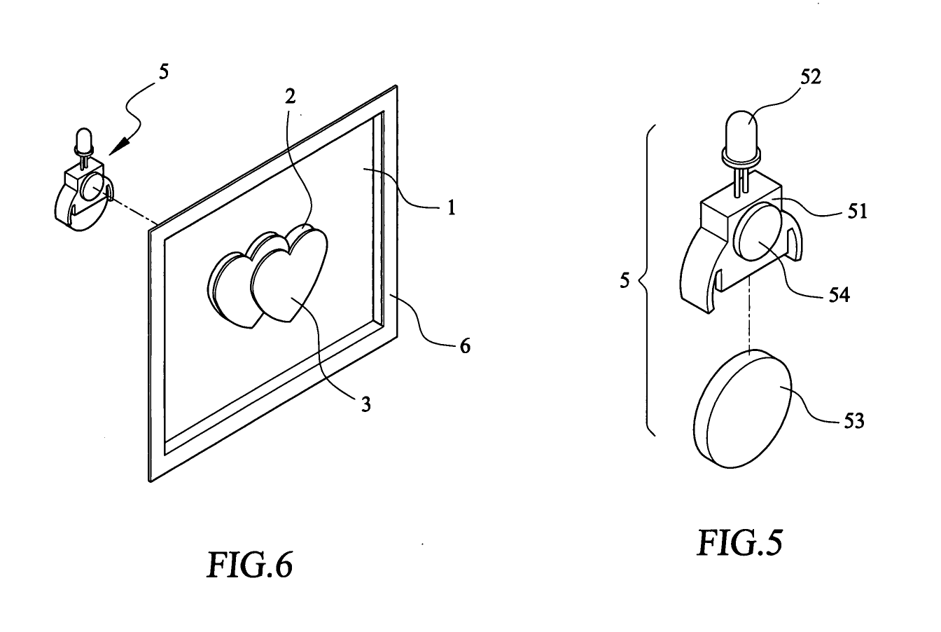

At least one light-emitting module 5 may be detachably connected to the rear or second surface 12 of the FIG. 3 or other areas on the sheet main body 1, as shown in FIGS. 3 and 4. As can be seen from FIG. 5, the light-emitting module 5 includes a housing 51, and at least one light-emitting element 52 and at least one battery 53 received in the housing 51.

In a preferred embodiment of the present invention, the sheet main body 1 is made of a metal material, and the light-emitting module 5 may further include a magnetic element 54 for a user to freely magnetically attach the light-emitting module 5 to any desired position on the sheet main body 1 or the FIG. 3, so that light emitted from the light-emitting module 5 is projected to the pressed area 2 and visible from the first surface 11 of the sheet main body 1, creating a special visual effect on the decoration of the present invention.

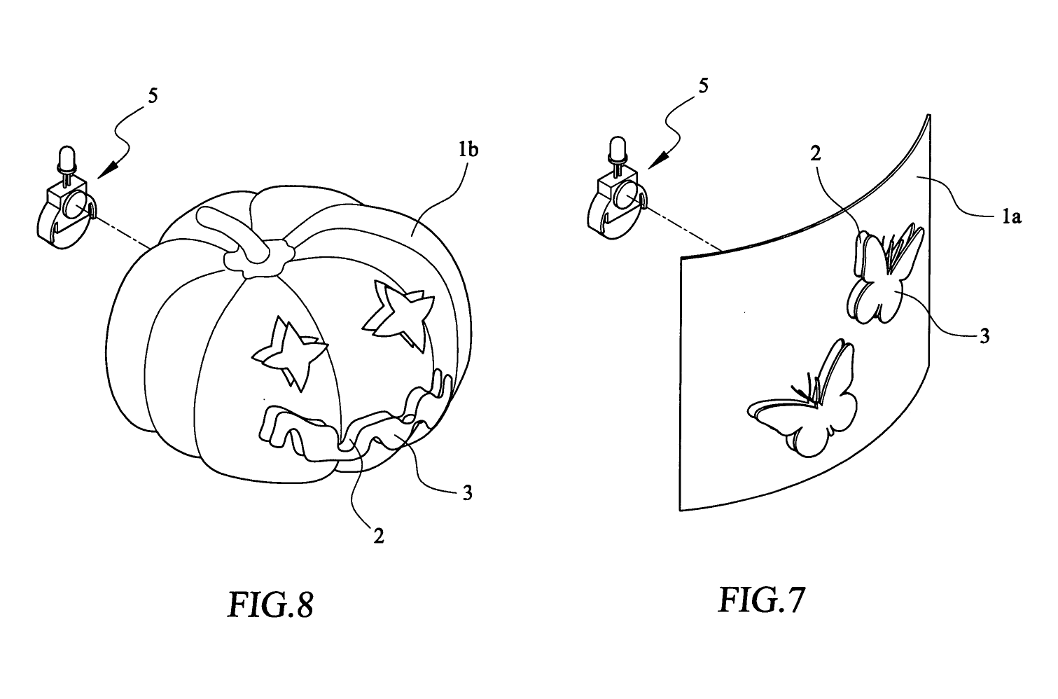

The decoration of the present invention is not necessarily in the shape shown in FIG. 1. Many other different shapes are also available for the present invention. FIG. 6 shows a decoration with three dimensional structure according to a second embodiment of the present invention including a picture frame 6 framing a sheet main body 1 therein. Of course, the sheet main body 1 has at least one pressed area 2 to show a desired FIG. 3 thereon. And, FIG. 7 shows a decoration with three dimensional structure according to a third embodiment of the present invention having a smoothly curved sheet main body 1a. FIG. 8 shows a decoration with three dimensional structure according to a fourth embodiment of the present invention having an approximately spherical main body 1b made of a sheet material to include, for example, a plurality of curved segments.

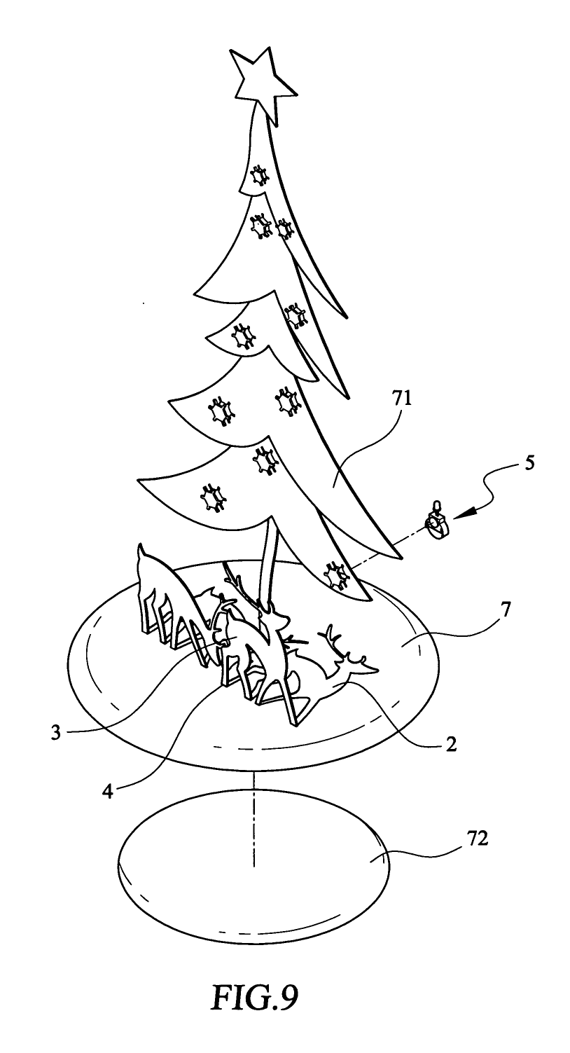

FIG. 9 is a perspective view of a decoration with three dimensional structure according to a fifth embodiment of the present invention having a substantially flat seat 7 adapted to horizontally position the decoration on a plane surface. A pressed area 2 is formed on the flat seat 7 to show a specific FIG. 3, which is connected to the flat seat 7 via at least one connecting sections 4 to maintain a desired position relative to the flat seat 7, such as being perpendicular to or tilted at an angle from the flat seat 7.

An additional ornament 71 matching the FIG. 3 may be provided on the flat seat 7. A backing block 72 showing a selected color may be attached to a bottom of the flat seat 7, so as to create a visual effect of showing a shadow of the FIG. 3 in the pressed area 2.

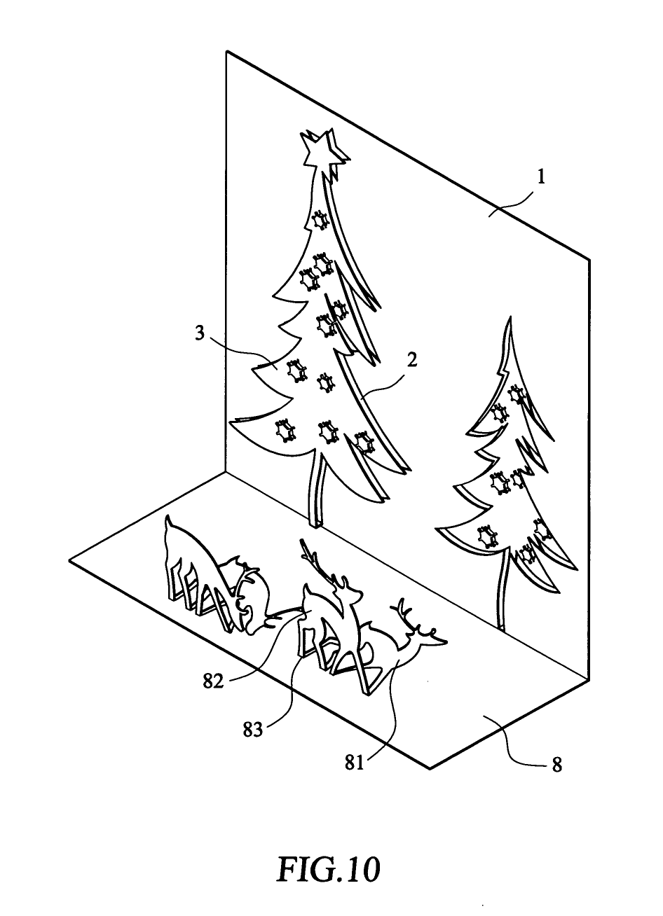

FIG. 10 is a perspective view of a decoration with three dimensional structure according to a sixth embodiment of the present invention having a sheet main body 1, on which a pressed area 2 is formed to show a specific FIG. 3, and a sideward extension 8 extended from one side of the sheet main body 1. The sideward extension 8 also has a selected area 81 being pressed from a bottom toward a top to show a specific FIG. 82, which is connected to the sideward extension 8 via at least one connecting section 83 to maintain a desired position relative to the sideward extension 8, such as being perpendicular to or tilted at an angle from the sideward extension 8. The sideward extension 8 is perpendicular to or tilted at an angle to the sheet main body 1.

The present invention has been described with some preferred embodiments thereof and it is understood that many changes and modifications in the described embodiments can be carried out without departing from the scope and the spirit of the invention that is intended to be limited only by the appended claims.

What is claimed is:

1. A decoration with three dimensional structure, comprising:
a sheet main body having a first surface and a second surface opposite to the first surface;
a pressed area being formed on said sheet main body by pressing a selected area of said sheet main body from the first surface toward the second surface by a predetermined distance;
a specific figure being formed on said sheet main body while said pressed area is formed, and having an outer configuration corresponding to an inner configuration of said pressed area; and
at least one connecting section extended between said specific figure and said sheet main body to maintain said specific figure at a desired position relative to said sheet main body.

2. The decoration with three dimensional structure as claimed in claim 1, further comprising at least one light-emitting module removably attached to the second surface of said sheet main body to emit and project light toward said pressed area, such that light emitted from said at least one light-emitting module is visible from the first surface of said sheet main body.

3. The decoration with three dimensional structure as claimed in claim 2, wherein said light-emitting module includes a housing, and at least one light-emitting element and at least one battery received in said housing.

4. The decoration with three dimensional structure as claimed in claim 1, wherein said specific figure is in parallel with said sheet main body.

5. The decoration with three dimensional structure as claimed in claim 1, wherein said specific figure is perpendicular to said sheet main body.

6. The decoration with three dimensional structure as claimed in claim 1, wherein said sheet main body includes a sideward extension which is perpendicular to the said sheet main body.

7. The decoration with three dimensional structure as claimed in claim 6, wherein said sideward extension further includes:
a pressed area being formed by pressing a selected area of said sideward extension;
a specific figure being formed while said pressed area is formed on said sideward extension, and having an outer configuration corresponding to an inner configuration of said pressed area; and
at least one connecting section extended between said specific figure and said sideward extension to maintain said specific figure at a desired position relative to said sideward extension.

8. The decoration with three dimensional structure as claimed in claim 1, wherein said sheet main body is smoothly curved.

9. The decoration with three dimensional structure as claimed in claim 1, wherein said sheet main body is formed into a closed spherical body.
